(19) United States
(12) Patent Application Publication
(10) Pub. No.: US 2015/0137965 A1
(43) Pub. Date: May 21, 2015

(54) Vehicular Sequential LED Ring Warning (VSLRW) System

(71) Applicants: Nicholas Aaron Lanham, Arlington, VA (US); David Louis Edelen, Charlotte Hall, MD (US)

(72) Inventors: Nicholas Aaron Lanham, Arlington, VA (US); David Louis Edelen, Charlotte Hall, MD (US)

(21) Appl. No.: 14/512,394

(22) Filed: Oct. 11, 2014

Related U.S. Application Data
(60) Provisional application No. 61/906,663, filed on Nov. 20, 2013.

(51) Int. Cl. B60Q 1/26; B60Q 1/44

(52) U.S. Cl. CPC B60Q 1/2696; B60Q 1/44
USPC 340/479

(57) ABSTRACT

Vehicular Sequential LED Ring Warning System is disclosed. This system improves upon existing taillight configurations by providing operators with distinct LED rings that sequential illuminate based upon the vehicle operator's braking intensity. This system will provide all drivers with a significantly more effective method of determining braking intensity. Using a simple and consistent sequence of three LED rings, the Sequential Warning System has the capacity to revolutionize existing brake light warning system design concepts by providing driver's with a decisive illumination pattern that simply replaces the vehicle's brake lights rather than adding a separate set of LED or light bulb arrays, which only increase driver confusion when simultaneously interpreting separate brake light signals.

### BACKGROUND OF THE INVENTION

### Problem Solved:

The Vehicular Sequential LED Ring Warning System will revolutionize the ways in which drivers react and interpret automobile brake light signals.

Existing taillight configurations provide little insight into the operator's braking intensity. In addition, other “progressive” braking systems do not provide a series of sequential LED rings to clearly identify the operator's braking force. Other “sequential” brake light configurations simply illuminate LED arrays in a unique pattern and are not based upon the driver's braking intensity. The remaining “progressive” and/or “sequential” brake light designs do not leverage vehicles' existing taillight positions, and rely upon incorporating another set of LED arrays in addition to the vehicles existing taillight configuration(s)—and create confusion during split-second braking decisions due to the addition of other LED arrays.

This system advances existing taillight configurations by providing operators with distinct LED rings that sequential illuminate based upon the vehicle operator's braking intensity.

### DETAILED DESCRIPTION OF THE INVENTION

As stated above, The Vehicular Sequential LED Ring Warning System will revolutionize the ways in which drivers react and interpret automobile brake light signals. The invention claimed here solves this problem.

The system has been developed solely to increase driver safety by providing increased clarity during any vehicular braking scenario. With distinct Light Emitting Diodes (LED) rings, the system will provide drivers with the ability to rapidly identify the intensity of other vehicles braking around them. Each LED ring is directly correlated to the intensity of the driver's braking intensity and clearly illustrates the level of stopping force being applied to the vehicle.

The claimed invention differs from what currently exists. Considering that brake light designs have remained virtually unchanged since the inception of automobiles, drivers have become accustomed to dedicating critical decision-making time to an attempt at calculating the rate of deceleration from other vehicles in front of, behind, and beside their vehicle. This allocation of time can lead to sometimes fatal accidents due to the driver's inability to accurately judge the braking speed of another vehicle and could also be blamed as one of the leading causes of “fender benders.” The Vehicular Sequential LED Ring Warning System is very unique and significantly differs from other “progressive” or “sequential” brake light design concepts by increasing the accuracy of operator braking intensity and overall vehicle safety by leveraging magnetic input sensors along with sequential LED rings rather than accelerometers, optic sensors, GPS driven devices, and/or other linear/circular LED array configurations that are in addition to the vehicles existing taillights and increase the time required to make life changing, split-second braking decisions.

During typical braking scenarios that use existing brake light designs, pursuing drivers have the ability to only interpret a set of single taillights that do not identify the intensity at which the lead vehicle is actually braking. There are many situations in which drivers do not have adequate time to make sound judgments regarding the speed of other vehicles around them. The Vehicular Sequential LED Ring Warning System provides drivers with a clearer method of determining braking intensity. Using a simple and consistent sequence of LED rings, the Vehicular Sequential LED Ring Warning System has the capacity to revolutionize the existing brake light design concepts by providing driver's with a decisive illumination in order to rapidly determine the braking intensity of other drivers. Without this system, automobile operators will continue to excessively “slam” on their brakes during routine stop-and-go traffic, increase their potential to be “rear-ended” by other pursuing driver's, and risk automobile accidents during routine braking scenarios that require other drivers to blindly determine other vehicle's braking intensity. In addition, vehicle operators will not benefit from rapidly comprehending the braking intensity of other drivers without this system. Existing design concepts that focus upon “progressive” or “sequential” warning systems are primarily based upon linear LED arrays and/or various other LED array designs that are not depending upon calculating the braking intensity of the lead vehicle.

This system improves upon existing taillight configurations by providing operators with distinct LED rings that sequential illuminate based upon the operator's braking intensity. Also, the system is flexible enough to accept any input type (i.e. native vehicle sensor outputs or other third-party sensor outputs) in order to sequentially illuminate a series of LED rings from inner (smallest ring, signifies least intense braking intensity) to the outer ring (largest ring, signifies most intense braking force). In addition, the outer ring (largest ring) is split between two arrays; the first LED array signifies the braking intensity of the operator while the second ring illuminates when the operator engages the turn signal and/or running lights. Even though this system has been developed using Hall Effect magnetic sensors as the input variable to the microprocessor however, the LED ring output signals can be controlled/operated by any input variable that most effectively illustrates the braking intensity of the vehicle's operator.

### The Version of The Invention Discussed Here Includes:

1. LED Ring Board

2. Input Senor Variable: This document includes a magnetic Hall Effect sensor (Housing & Assembly) as a native, or non-native, vehicle output sensor emulator

3. Processor

4. Ancillaries

### Relationship Between The Components:

Item/Step Number #1 LED Ring System

The LED ring system is what holds the LEDs as well as supplies them with the necessary electricity to function. The boards may not be visible; however the LED will be able to be seen inside the tail light lens from outside the car.

### Item/Step Number #2 Sensor System (Housing & Assembly)

The current version of the system includes a magnetic sensor system comprised of the magnet housing and the sensor housing. This will be located under the dash and configured into the brake pedal system. These components will not be visible from the driver seat, but could be seen if you where to look under the dash. However, this system is flexible and can accept sensor inputs from any native, or non-native vehicle sensor output or other non-native sensor installation (i.e. accelerometer, GPS, lasers, hall effect sensors, etc.). This invention uses the existing Hall Effect sensor as an emulator to accept vehicle pressure sensor output similar to any other native, or non-native, vehicle output sensor or computer signal to be used as an input sensor variable to the said Vehicular Sequential LED Ring Warning System.

### Item/Step Number #3 Processor

The processor has code written and saved on it to accurately differentiate how many rings to illuminate based on the braking intensity. The processor system has several other electronic components to support full functionality and simultaneously control the LED rings when the brake has been applied as well as during turn signal and/or running light engagement. The processor system will be concealed within the car and wired directly to the vehicle's DC power source as well as to the left and right taillight assemblies.

### Item/Step Number #4 Ancillaries

Power connecting plugs are used with items 1, 2, and 3, as well as resistors, capacitors, and printed circuit boards. A permanent magnet and Hall Effect sensor are used in item 2. A micro controller is used to with item 3. When the operator of the vehicle is in a braking scenario, the driver applies the brakes and the cars hydraulic brake system functions as it normally would. A magnet stored in a housing (item 2) located on the brake pedal comes into the proximity of the sensor (item 2) in which the sensors sends a signal.

The strength of the signal is directly related to the proximity of the magnet to the Hall Effect sensor, which results in an extremely accurate method of calculating how hard the operator of the vehicle is braking. The harder the driver brakes, the closer the magnet gets to the sensor (item 2) and the stronger the signal. The signal is then used as in input for the processor (item 3). Through the installed software, the processor creates the appropriate output for the LED rings system (item 1). Both the signal from the magnet sensor (item 2) and the signals from the processor (item 3) travel through conductive wires. The signal arrives at the LED ring system (item 1) and lights the designated number of rings associated with the intensity of the braking. This has now illuminated the ring(s) and indicates to other drivers the braking force of the vehicle operator applying their brakes. Important Note: This design concept incorporates the input signals received from the magnetic sensor as the primary input data being processed and sent to the sequential LED ring(s). This input approach represents an example of an input sensor which could be comprised of numerous other sensors, hardware devices, and/or data transferred from the vehicle's internal computer. The described Sequential LED Ring warning system is extremely flexible and can accept input from any type of sensor, hardware, and/or internal computing device to control the illumination of LED rings.

### How The Invention Works:

When the operator of the vehicle is in a braking scenario, the driver applies the brakes and the vehicle's hydraulic brake system functions as normally. A magnet stored in the housing (item 2) located on the brake pedal comes into proximity of the sensor (item 2) in which the sensors sends a signal. The strength of the Hall Effect magnetic input signal is directly proportional to the braking intensity of the vehicle operator. The harder the driver brakes, the closer the magnet gets to the Hall Effect sensor (item 2) and the stronger the signal. The signal is then used as in input for the processor (item 3). Through the installed software, the processor creates the appropriate output for the LED rings system (item 1). Both the signal from the magnet sensor (item 2) and the signals from the processor (item 3) travel through conductive wires. The signal arrives at the LED ring system (item 1) and lights the designated number of rings associated with the intensity of the braking. This has now illuminated the ring(s) and indicates to followers how much the operator of the vehicle is braking.

The primary logic specific to the discussed design analyzes the input voltage received from the magnetic senor subsystem which is then processed and computed via the processor attached to the sequential LED ring board. The embedded subroutine analyzes the input voltage being received from the magnetic sensor and calculates the intensity of the operator's braking force, then processes this data in order to determine the number of individual LED rings to power/illuminate.

### How To Make The Invention:

Design and develop LED Ring printed circuit board, design and develop software to control LED illumination logic, develop magnetic sensor housing and assembly, machine associated components, integrate processor housing, complete proper wiring assemblies/connections, and integrate within a vehicle.

All items described are essential to the operation and overall design concept of the Vehicular Sequential LED Ring Warning System. Without one, or any of the described hardware and associated software components the system will not achieve the desired LED Ring warning effects. As outlined within other areas of this application for patent, the Vehicular Sequential LED Ring warning system is very flexible and adaptable, and has been specifically designed to accept any input variable (i.e. optical sensors, laser sensors, pressure sensors, data directly from the vehicle's onboard computer, etc.). Due to the system's unique design allows for the highly effective LED Ring configuration to simply replace the vehicle's existing taillight assembly. This system increases overall effectiveness and eliminates any type of confusion generated from other patent designs that require the addition of another LED array assembly located outside or away from the vehicle's typical brake light position.

Considering the Vehicular Sequential LED Ring system's adaptability and flexibility, multiple LED Ring configurations could be developed (i.e. 3 versus 4 or 5 rings and round versus square or linear). Microprocessor components could be replaced with a series of logic gates. Magnetic sensors could be replaced with and accelerometer, laser range finder, load sensor, floor sensor, motion sensor, pressure sensor, position sensor, tilt sensor, wireless component/sensor interaction, and/or optical sensor(s). However, the described Vehicular Sequential LED Ring Warning System design optimizes the use of LED Rings to rapidly identify the intensity of the operator's braking force.

### How To Use The Invention:

During typical braking scenarios that use existing brake light designs, pursuing drivers only have the ability to interpret single set of standard taillights that do not indicate how hard the lead vehicle is actually braking. There are many situations in which drivers do not have adequate time to make sound judgments regarding the speed of the vehicles around them. This system will provide all drivers with a significantly more effective method of determining braking intensity. Using a simple and consistent sequence of three LED rings, the Sequential Warning System has the capacity to revolutionize existing brake light warning system design concepts by providing driver's with a decisive illumination pattern that simply replaces the vehicle's brake lights rather than adding a separate set of LED or light bulb arrays, which only increase driver confusion when simultaneously interpreting separate brake light signals. Without this system, automobile operators will continue to excessively “slam” on their brakes during routine stop-and-go traffic, increase their potential to be “rear-ended” by other pursuing driver's, and increase automobile accident risk during routine braking scenarios that require other drivers to blindly determine the braking intensity of other vehicles around them. The described Vehicular Sequential LED Ring Warning System provides drivers with a much more effective method of determining braking intensity. Using a simple and consistent sequence of three LED rings, the Sequential Warning System has the capacity to revolutionize the existing brake light warning system design concept by providing driver's with a decisive illumination in order to rapidly determine the braking intensity of other drivers. Current taillight designs limit the ability of drivers to effectively determine the braking intensity of other vehicles, and even though these designs have offered inexpensive illumination solutions, existing taillight design concepts limit the operator's ability to safely calculate the deceleration of other vehicles on the road. As the primary focal point of all drivers pursuing other vehicle(s), the taillight and turn signals offer the only feedback for which other drivers can make braking and maneuvering decisions. Considering a scenario where a single driver is following two different vehicles, existing taillight designs will significantly limit the operator's ability to safely estimate the braking intensity of two separate vehicles applying their brakes at the same time due to an impending obstacle.

With this scenario, it becomes apparent that the driver must calculate several things in order to make the safest maneuvering decision, one of which is working to calculate which vehicle in front of him/her is decelerating at a more intense rate? Because both vehicles within this scenario are using standard taillight designs, both vehicles will simply indicate that both taillights are illuminated as normal, and both are decelerating. However, neither of the vehicles have the ability to show the pursuing driver which vehicle is stopping more rapidly than the other—a fact that could severely limit the ability of the pursing driver to determine what direction a potential accident or danger is approaching.

### DRAWING DESCRIPTION

FIG. 1: is a rear view of the invention shown in use.

FIG. 2: is a top vie of an invention component (16 mounting bracket).

FIG. 3: is a front view of an invention component (16 mounting bracket).

FIG. 4: is a schematic view of the invention overall operation.

FIG. 5: is a front view of an alternate embodiment of the invention.

FIG. 6: is a rear view of an alternate embodiment of the invention shown in use.

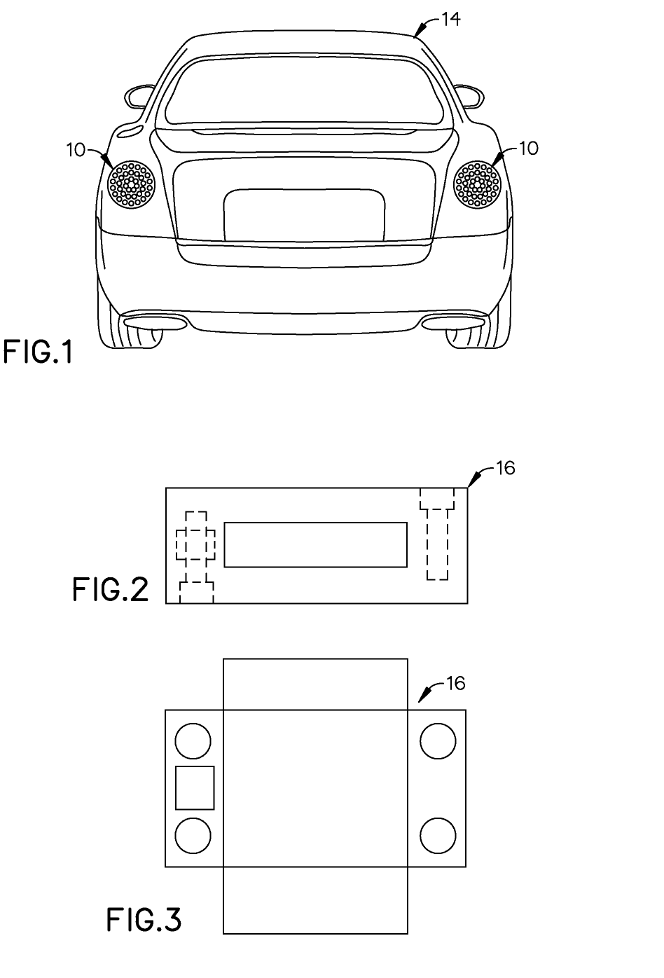

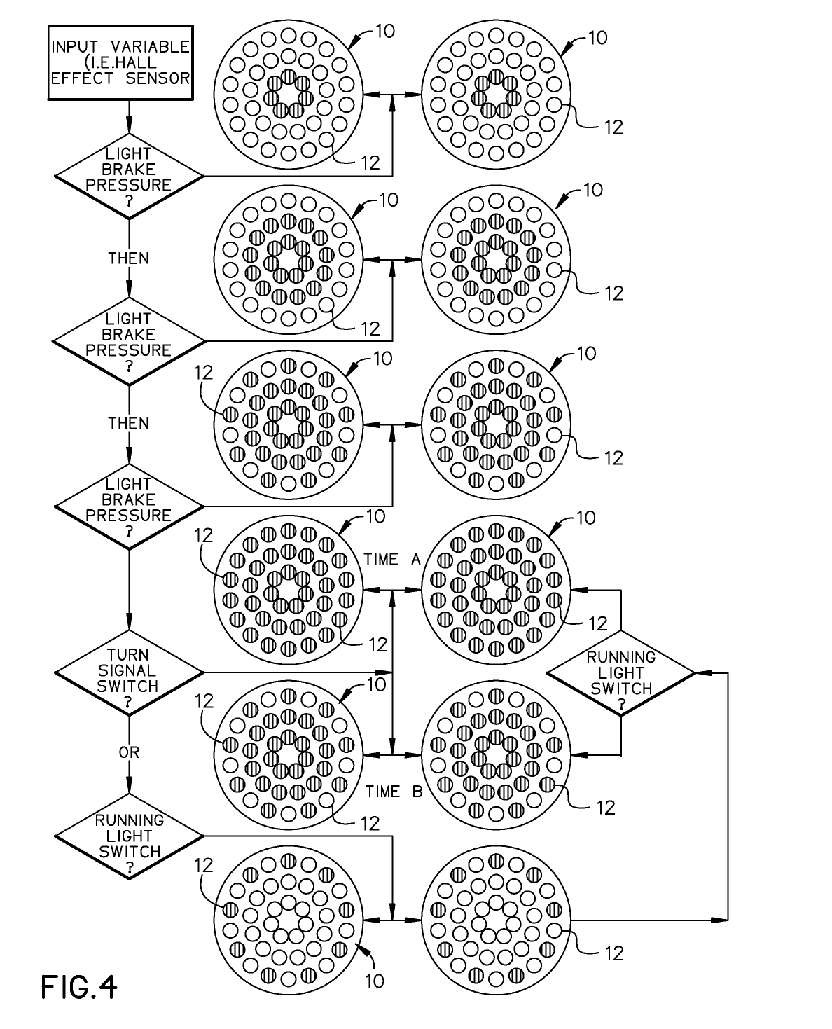

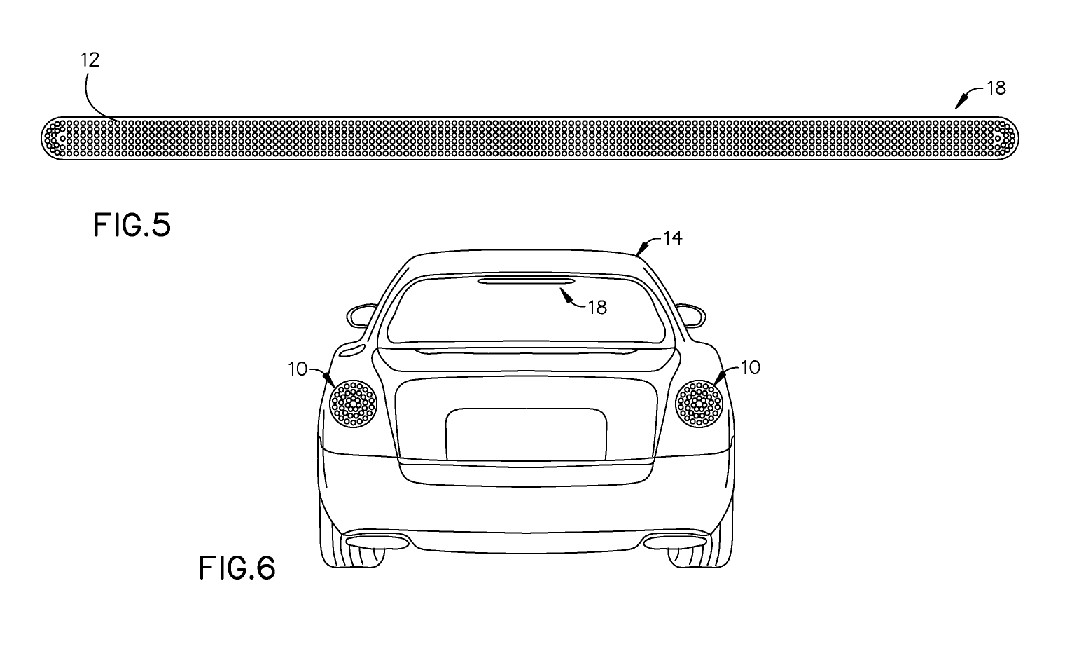

### DESCRIPTION LIST

10: is the sequential ring taillight.
12: is the LED.
14: is the exemplary vehicle.
16: is the mounting bracket.
18: is the sequential ring taillight (third taillight location)

1. A Vehicular Sequential LED Ring Warning System comprising of three separate arrays of LED rings (i.e., any circular or non-circular, continuous shape that arranged smallest to largest, with the smallest in the center, encircled by the second and third shapes) within a sequential LED ring taillight assembly, separate LED rings, sensor processor, and the sequential taillight ring (third taillight location).

2. The said Vehicular Sequential LED Ring Warning System as in claim 1 is whereby activated by native vehicle, or non-native vehicle, sensor outputs that are used as inputs within the said processor in order to trigger LED ring illumination from the smallest inner ring to the outermost ring.

3. The said Vehicular Sequential LED Ring Warning System processor as in claim 2 includes logic that calculates native vehicle, or non-native vehicle, sensor outputs and calculates the vehicles breaking intensity in order to sequentially illuminate each LED ring housed within the said LED ring taillight assembly and third taillight location sequential ring.

4. The said LED ring taillight assembly and third taillight location LED rings as in claims 1-3 are illuminated in a sequential pattern starting from the smallest, inner-most ring, and moving sequentially to the next outer-most ring relative to the breaking intensity calculated by the said processor unit. Each of the three LED rings is programmed to illuminate in the event that pre-programmed sensor output thresholds have been breached. This is a unique routine that keeps each LED ring illuminated as the senor output intensity increases and sequentially breaks pre-determined sensor values.
